(19) United States
(12) Patent Application Publication
(10) Pub. No.: US 2021/0323558 A1
(43) Pub. Date: Oct. 21, 2021

(54) INFORMATION PROCESSING APPARATUS, INFORMATION PROCESSING SYSTEM, PROGRAM, AND VEHICLE

(71) Applicant: TOYOTA JIDOSHA KABUSHIKI KAISHA, Toyota-shi (JP)

(72) Inventors: Tooru NAKANISHI, Nagakute-shi (JP); Tadashi YAMADA, Toyota-shi (JP); Josuke YAMANE, Nissin-shi (JP); Mitsuhiro MIURA, Toyota-shi (JP); Tomo SASAKI, Toyota-shi (JP); Tomoyuki KOZUKA, Toyota-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 17/217,197

(22) Filed: Mar. 30, 2021

(30) Foreign Application Priority Data
Apr. 21, 2020 (JP) 2020-075656

(51) Int. Cl. B60W 40/08; G06Q 10/02; G06Q 50/12; G01C 21/34

(52) U.S. Cl. CPC B60W 40/08; G06Q 10/02; B60W 2540/26; G01C 21/3484; B60W 2540/221; G06Q 50/12

(57) ABSTRACT

An information processing apparatus includes a control unit. The control unit is configured to acquire traveling information of one vehicle and appearance information of an occupant of the one vehicle, which are obtained in association with driving of the one vehicle to a lodging facility, estimate biological information of the occupants of the vehicle by comparing the acquired traveling information and the acquired appearance information with traveling information and appearance information previously obtained in association with driving of other vehicles, and determine first information associated with a service provided at the lodging facility. The service is matched with the estimated biological information.

### CROSS-REFERENCE TO RELATED APPLICATION

This application claims priority to Japanese Patent Application No. 2020-075656 filed on Apr. 21, 2020, incorporated herein by reference in its entirety.

### BACKGROUND

### 1. Technical Field

The present disclosure relates to an information processing apparatus, an information processing system, a program, and a vehicle.

### 2. Description of Related Art

Conventionally, technologies associated with services provided to guests by lodging facilities are well-known. For example, Japanese Unexamined Patent Application Publication No. 2016-224609 (JP 2016-224609 A) discloses an information provision system that provides useful information for a guest based on attribute information of the guest. The information provision system described in JP 2016-224609 A determines a language used by the guest based on the attribute information including at least one of the guest's address, nationality, and language used. The information provision system described in JP 2016-224609 A forms an image on a print medium that provides lodging facility information preset as information associated with the lodging facility in the determined language.

### SUMMARY

However, such a technology has a shortcoming in that biological information of occupants including a driver cannot be obtained when the driver drives a vehicle to the lodging facility. Therefore, it is difficult to accurately find out what services the occupants want to be offered in the lodging facility based on, for example, the biological information of the occupants.

The present disclosure makes it possible to optimize a service provided at the lodging facility to meet the needs of the occupants of the vehicle, based on the biological information of the occupants.

An information processing apparatus according to one embodiment of the present disclosure includes a control unit configured to acquire traveling information of one vehicle and appearance information of an occupant of the one vehicle, which are obtained in association with driving of the one vehicle to a lodging facility, estimate biological information of the occupant of the one vehicle by comparing the acquired traveling information and the acquired appearance information with traveling information and appearance information previously obtained in association with driving of other vehicles, and determine first information associated with a service provided at the lodging facility. The service is matched with the estimated biological information.

A program according to one embodiment of the present disclosure is a program causing an information processing apparatus to execute an operation. The operation includes acquiring traveling information of one vehicle and appearance information of an occupant of the one vehicle, which are obtained in association with driving of the one vehicle to a lodging facility, estimating biological information of the occupant of the one vehicle by comparing the acquired traveling information and the acquired appearance information with traveling information and appearance information previously obtained in association with driving of other vehicles, and determining first information associated with a service provided at the lodging facility. The service is matched with the estimated biological information.

A vehicle according to one embodiment of the present disclosure includes a control unit configured to acquire traveling information of the vehicle and appearance information of an occupant of the vehicle, which are obtained in association with driving of the vehicle to a lodging facility, estimate biological information of the occupant of the vehicle by comparing the acquired traveling information and the acquired appearance information with traveling information and appearance information previously obtained in association with driving of other vehicles, and determine first information associated with a service provided at the lodging facility. The service is matched with the estimated biological information.

The information processing apparatus, the information processing system, the program, and the vehicle according to one embodiment of the present disclosure make it possible to optimize a service provided at the lodging facility to meet the needs of the occupants of the vehicle, based on the biological information of the occupants.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating a configuration of an information processing system including an information processing apparatus according to one embodiment of the present disclosure;

FIG. 2 is a functional block diagram illustrating a schematic configuration of each of the information processing apparatus, a first terminal device, a second terminal device, and a vehicle, shown in FIG. 1;

FIG. 3 is a diagram illustrating a first example of processing executed by a control unit of the information processing apparatus shown in FIG. 2;

FIG. 4 is a first diagram illustrating a second example of the processing executed by the control unit of the information processing apparatus shown in FIG. 2;

FIG. 5 is a second diagram illustrating the second example of the processing executed by the control unit of the information processing apparatus shown in FIG. 2;

FIG. 6 is a diagram illustrating a third example of the processing executed by the control unit of the information processing apparatus shown in FIG. 2;

FIG. 7 is a first diagram illustrating a fourth example of the processing executed by the control unit of the information processing apparatus shown in FIG. 2;

FIG. 8 is a second diagram illustrating the fourth example of the processing executed by the control unit of the information processing apparatus shown in FIG. 2;

FIG. 9 is a flowchart illustrating a first example of an information processing method executed by the information processing apparatus shown in FIG. 1; and

FIG. 10 is a flowchart illustrating a second example of the information processing method executed by the information processing apparatus shown in FIG. 1.

### DETAILED DESCRIPTION OF EMBODIMENTS

Hereinafter, embodiments of the present disclosure will be described with reference to drawings.

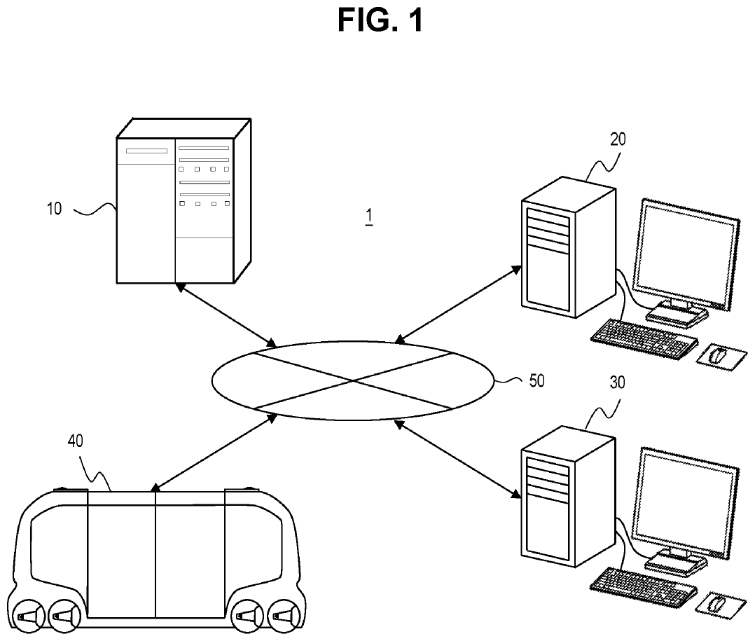

FIG. 1 is a configuration diagram illustrating a configuration of an information processing system 1 including an information processing apparatus 10 according to an embodiment of the present disclosure. Referring to FIG. 1, an outline of the information processing system 1 including the information processing apparatus 10 according to the embodiment of the present disclosure will be mainly described. The information processing system 1 has a first terminal device 20, a second terminal device 30, and a vehicle 40, as well as the information processing apparatus 10. Although FIG. 1 shows one information processing apparatus 10, one first terminal device 20, one second terminal device 30, and one vehicle 40 for a simple explanation, the numbers of the information processing apparatuses 10, the first terminal devices 20, the second terminal devices 30, and the vehicles 40, included in the information processing system 1, may be two or more, respectively. Each of the information processing apparatus 10, the first terminal device 20, the second terminal device 30, and the vehicle 40 is connected so as to be communicable via a network 50 such as a mobile communication network and the internet.

The information processing apparatus 10 is one or more server devices which can communicate with each other. However, the information processing apparatus 10 is not limited thereto, and may be any general-purpose electronic device such as a personal computer (PC) or a smartphone, or alternatively, may be another electronic device dedicated to the information processing system 1.

The first terminal device 20 may be, for example, a general-purpose electronic device such as a personal computer or a smartphone. The first terminal device 20 may be, for example, an electronic device used by a manager of a lodging facility where occupants of the vehicle 40 will stay. The number of occupants of the vehicle 40 may be one or more. The first terminal device 20 is not limited thereto, and may be one or more server devices which can communicate with each other, used in the lodging facility, or alternatively, may be an electronic device dedicated to the information processing system 1.

The second terminal device 30 may be, for example, a general-purpose electronic device such as a personal computer or a smartphone. The second terminal device 30 may be, for example, an electronic device used by a manager of a service facility existing on a travel route to the lodging facility. The second terminal device 30 is not limited thereto, and may be one or more server devices which can communicate with each other and which are used in the service facility, or alternatively, may be an electronic device dedicated to the information processing system 1.

The vehicle 40 is, for example, an automobile. The vehicle 40 is not limited to an automobile and may be any vehicle that people can board and travel to the lodging facility by. The vehicle 40 may be, for example, a vehicle traveling by autonomous traveling. The term “autonomous traveling” herein may refer to, for example, levels 1 to 5 of autonomous traveling as defined by the Society of Automotive Engineers (SAE), but is not limited thereto and may be arbitrarily defined. The vehicle 40 is not limited to a vehicle traveling by autonomous traveling and may be any vehicle driven by a driver.

As an outline of the embodiment, the information processing apparatus 10 acquires traveling information of the vehicle 40 and appearance information of the occupants of the vehicle 40, which are obtained in association with driving of the vehicle 40 to the lodging facility. In the detailed description, the “traveling information” includes, for example, any information obtained in association with traveling of the vehicle 40, which is acquired by the vehicle 40 when the vehicle 40 travels on the travel route to the lodging facility. The traveling information includes, for example, speed of the vehicle 40 (including average vehicle speed), acceleration, angular velocity, steering, time during which the occupants are present in the vehicle, traveling lane, air conditioning information within the vehicle, and autonomous traveling state. In the detailed description, the “appearance information” includes, for example, age, sex, clothing, and race.

The information processing apparatus 10 compares the traveling information and the appearance information, acquired from the vehicle 40, with traveling information and appearance information previously obtained in association with driving of another vehicle, thereby estimating biological information of the occupants of the vehicle 40. In the detailed description, the “biological information” includes, for example, fatigue level, hunger level, and excitement level. The biological information may be represented using any index. For example, the biological information may be represented by a numerical value falling within any optional numerical range. For example, the biological information may be represented by a numerical value from 0 to 100. In such a case, the larger the value that represents the biological information, the higher the level of the biological information of the occupants. On the contrary, the smaller the value that represents the biological information, the lower the level of the biological information of the occupants. The biological information is not limited thereto and may be represented by, for example, any of three levels, for example, “high”, “medium” and “low.”

The information processing apparatus 10 determines first information associated with a service provided at the lodging facility, which matches the estimated biological information. In the detailed description, the “first information” includes, for example, details of the services provided at the lodging facility. The “lodging facility” herein may be reserved by the occupants of the vehicle 40 in advance, and as will be described later, may be selected as the lodging facility that matches the appearance information and the number of the occupants of the vehicle 40, from among candidate lodging facilities.

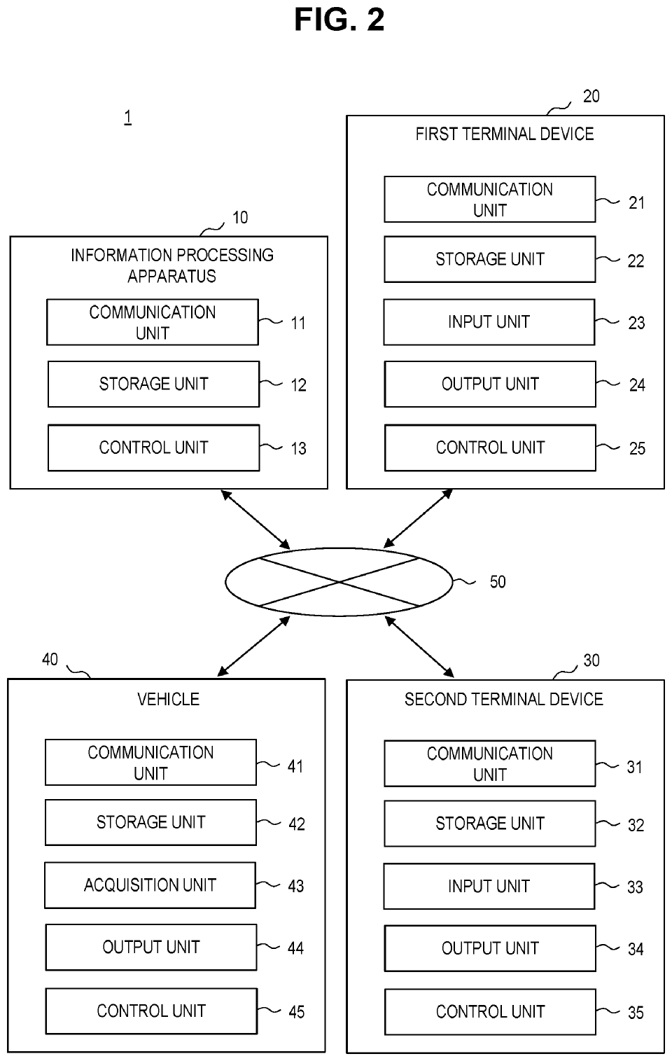

Referring to FIG. 2, a configuration of each of the information processing apparatus 10, the first terminal device 20, the second terminal device 30, and the vehicle 40, included in the information processing system 1, will be mainly described. FIG. 2 is a functional block diagram illustrating a schematic configuration of each of the information processing apparatus 10, the first terminal device 20, the second terminal device 30, and the vehicle 40, shown in FIG. 1.

As shown in FIG. 2, the first terminal device 20 includes a communication unit 21, a storage unit 22, an input unit 23, an output unit 24, and a control unit 25.

The communication unit 21 has a communication module connected to a network 50. For example, the communication unit 21 may include a communication module corresponding to a mobile communication standard such as 4G (4th Generation), 5G (5th Generation), or alternatively, to the internet protocol. In the embodiment, the first terminal device 20 is connected to the network 50 via the communication unit 21. The communication unit 21 transmits and receives various types of information via the network 50.

The storage unit 22 may be, for example, a semiconductor memory, a magnetic memory, or an optical memory, but is not limited thereto. The storage unit 22 may function as, for example, a main storage device, an auxiliary storage device, or a cache memory. The storage unit 22 stores random information used in the operations of the first terminal device 20. The storage unit 22 may store, for example, a system program, an application program, and various types of information received by the communication unit 21. The information stored in the storage unit 22 may be updated by, for example, information received by the network 50 via the communication unit 21.

The input unit 23 includes one or more input interfaces that detect a user's input and acquire input information as operated by a user. For example, the input unit 23 may be, but is not limited to, physical keys, capacitance keys, a touchscreen provided integrally with a display of the output unit 24, or a microphone that accepts voice input.

The output unit 24 includes one or more output interfaces that output information so as to notify the user. For example, the output unit 24 may be, but is not limited to, a display that outputs information as a video, or a speaker that outputs information as audio.

The control unit 25 includes one or more processors. The “processor” in the embodiment is a general-purpose processor or a dedicated processor specialized for a specific processing, but is not limited thereto. The control unit 25 is communicably connected to components constituting the first terminal device 20 and controls the operations of the entire first terminal device 20.

For example, the control unit 25 receives the first information determined by the information processing apparatus 10 from the information processing apparatus 10 via the network 50 and the communication unit 21. For example, the control unit 25 transmits facility information of the lodging facility stored in the storage unit 22 to the information processing apparatus 10 via the communication unit 21 and the network 50. In the detailed description, the “facility information of the lodging facility” includes, for example, location information of the lodging facility, vacancy information of the lodging facility, and information on the facilities of the lodging facility.

Hereinbelow, the configuration of the second terminal device 30 included in the information processing system 1 will be mainly described. As shown in FIG. 2, the second terminal device 30 includes a communication unit 31, a storage unit 32, an input unit 33, an output unit 34, and a control unit 35. The same description as for each of the corresponding components of the first terminal device 20 applies to each of the components of the second terminal device 30.

In the second terminal device 30, for example, the control unit 35 receives second information, which is determined by the information processing apparatus 10 so as to be matched with the biological information, from the information processing apparatus 10 via the network 50 and the communication unit 31. The second information is associated with a service provided at the service facility existing on the travel route to the lodging facility, and the occupants of the vehicle 40 which is traveling are informed of the second information. In the detailed description, the “second information” includes, for example, details of the services provided at the service facility. The “service facility” herein may be, for example, selected by the information processing apparatus 10 as the service facility matching a driving history of the occupants of the vehicle 40, from among candidate service facilities.

For example, the control unit 35 transmits facility information of the service facility stored in the storage unit 32 to the information processing apparatus 10 via the communication unit 31 and the network 50. In the detailed description, the “facility information of the service facility” includes, for example, location information of the service facility, a type of the service facility, and information on facilities included in the service facility.

Hereinbelow, the configuration of the vehicle 40 included in the information processing system 1 will be mainly described. As shown in FIG. 2, the vehicle 40 includes a communication unit 41, a storage unit 42, an acquisition unit 43, an output unit 44, and a control unit 45. The communication unit 41, the storage unit 42, the acquisition unit 43, the output unit 44, and the control unit 45 are connected to each other through, for example, an in-vehicle network such as a CAN (Controller Area Network) or a dedicated line, whereby the components can communicate with each other.

The communication unit 41 has a communication module connected to the network 50. The communication unit 41 may include, for example, communication modules corresponding to a mobile communication standard, such as 4G or 5G. In the embodiment, the vehicle 40 is connected to the network 50 via the communication unit 41. The communication unit 41 transmits and receives various types of information via the network 50.

The storage unit 42 may be, for example, a semiconductor memory, a magnetic memory, or an optical memory, but is not limited thereto. The storage unit 42 may function as, for example, a main storage device, an auxiliary storage device, or a cache memory. The storage unit 42 stores random information used in the operations of the vehicle 40. The storage unit 42 stores, for example, the driving history of the occupants of the vehicle 40. In the detailed description, the “driving history” includes, for example, a date and time when a driver drives, information on locations where the driver drives, and information on places where the occupants stop. Furthermore, the storage unit 42 may store, for example, a system program, an application program, and various types of information received by the communication unit 41. The information stored in the storage unit 42 may be updated by, for example, information received by the network 50 via the communication unit 41.

The acquisition unit 43 includes an optional module capable of acquiring various types of traveling information. For example, the acquisition unit 43 includes a sensor module capable of acquiring various types of traveling information related to the vehicle 40. The acquisition unit 43 includes an optional module capable of acquiring various types of appearance information and the number of the occupants. For example, the acquisition unit 43 includes a camera module that is installed within the vehicle 40 and is connected to the CAN, and is capable of acquiring the appearance information and the number of the occupants, as well as any other type of sensor modules.

Furthermore, the acquisition unit 43 includes one or more receivers corresponding to a random satellite positioning system. For example, the acquisition unit 43 may include a GPS (Global Positioning System) receiver. The acquisition unit 43 acquires a measured location of the vehicle 40 as the location information. The location information includes, for example, address, latitude, longitude and altitude. The acquisition unit 43 may constantly acquire the location information of the vehicle 40, or may acquire the location information periodically or irregularly.

The output unit 44 outputs, for example, the first information and the second information, determined by the information processing apparatus 10, to the occupants of the vehicle 40, as well as the facility information of the lodging facility and the service facility. The output unit 44 includes, for example, a car navigation device. The output unit 44 includes, for example, an output device such as a liquid crystal monitor constituting the car navigation device. The car navigation device constituting the output unit 44 outputs, for example, information by at least one of images and sounds.

The output unit 44 is not limited thereto, and may include any output device stimulating at least one of sight and hearing of the occupants of the vehicle 40. The output unit 44 may include, for example, any audio output device that mainly stimulates the hearing of the occupants of the vehicle 40, other than the car navigation device. The output unit 44 may include, for example, any image output device that mainly stimulates the sight of the occupants of the vehicle 40, other than the car navigation device.

The control unit 45 includes one or more processors. The “processor” in the embodiment is a general-purpose processor or a dedicated processor specialized for a specific processing, but is not limited thereto. The control unit 45 may include, for example, an electronic control unit (ECU). The control unit 45 is communicably connected to components constituting the vehicle 40 and controls the operations of the entire vehicle 40.

For example, the control unit 45 receives the first information and the second information, determined by the information processing apparatus 10, from the information processing apparatus 10 via the network 50 and the communication unit 41. The control unit 45 receives, for example, the facility information of the lodging facility associated with the first information from the information processing apparatus 10 via the network 50 and the communication unit 41. The control unit 45 receives, for example, the facility information of the service facility associated with the second information from the information processing apparatus 10 via the network 50 and the communication unit 41.

The control unit 45 transmits, for example, the traveling information, the appearance information, the number of the occupants, and the location information, acquired by the acquisition unit 43, to the information processing apparatus 10 via the communication unit 41 and the network 50. The control unit 45 transmits, for example, the driving history stored in the storage unit 42 to the information processing apparatus 10 via the communication unit 41 and the network 50.

Hereinbelow, the configuration of the information processing apparatus 10 included in the information processing system 1 will be mainly described. As shown in FIG. 2, the information processing apparatus 10 includes a communication unit 11, a storage unit 12, and a control unit 13.

The communication unit 11 has a communication module connected to the network 50. For example, the communication unit 11 may include a communication module corresponding to a mobile communication standard such as 4G or 5G, or alternatively, to the internet protocol. In the embodiment, the information processing apparatus 10 is connected to the network 50 via the communication unit 11. The communication unit 11 transmits and receives various types of information via the network 50.

The storage unit 12 may be, for example, a semiconductor memory, a magnetic memory, or an optical memory, but is not limited thereto. The storage unit 12 may function as, for example, a main storage device, an auxiliary storage device, or a cache memory. The storage unit 12 stores random information used in the operations of the information processing apparatus 10. The storage unit 12 may store, for example, a system program, an application program, and various types of information received by the communication unit 11. The information stored in the storage unit 12 may be updated by, for example, information received by the network 50 via the communication unit 11.

The control unit 13 includes one or more processors. The “processor” in the embodiment is a general-purpose processor or a dedicated processor specialized for a specific processing, but is not limited thereto. The control unit 13 is communicably connected to components constituting the information processing apparatus 10 and controls the operations of the entire information processing apparatus 10.

For example, the control unit 13 receives the traveling information, the appearance information, the number of the occupants, and the location information, acquired by the acquisition unit 43 of the vehicle 40, from the vehicle 40 via the communication unit 11 and the network 50. The control unit 13 compares the traveling information and the appearance information, received by the communication unit 11, with the traveling information and the appearance information previously obtained in association with the driving of the other vehicle. In such a case, the control unit 13 may acquire, for example, big data, in which the traveling information and the appearance information previously obtained in association with the driving of the other vehicle are associated with the biological information of the occupants of the other vehicle, from the other optional external device via the network 50 and the communication unit 11, and store the big data in the storage unit 12. The control unit 13 may compare, for example, the traveling information and the appearance information received from the vehicle 40 by the communication unit 11 with the big data stored in the storage unit 12.

The control unit 13 estimates the biological information of the occupants of the vehicle 40 by the comparison stated above. The control unit 13 determines the first information associated with the service provided at the lodging facility, which matches the estimated biological information. The control unit 13 transmits, for example, the determined first information to the first terminal device 20 and the vehicle 40 via the communication unit 11 and the network 50.

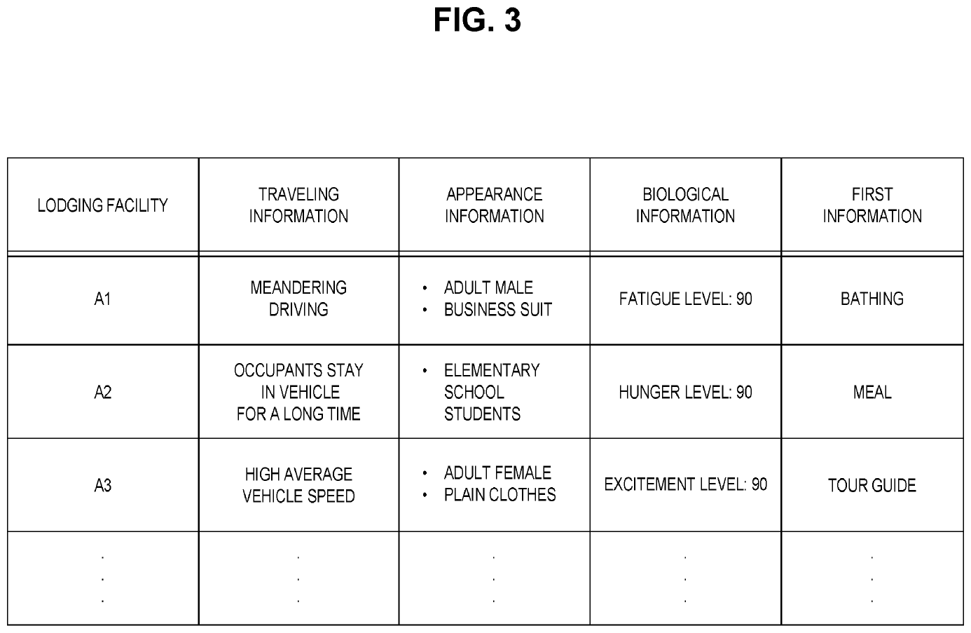

FIG. 3 is a diagram illustrating a first example of the processing executed by the control unit 13 of the information processing apparatus 10 shown in FIG. 2. Referring to FIG. 3, the first example of the processing executed by the control unit 13 will be described more specifically. In the first example of the processing executed by the control unit 13, the biological information is estimated based on the traveling information and the appearance information, acquired by the control unit 13, to determine the first information. Three lodging facilities A1, A2 and A3 are shown in FIG. 3, but the number of the lodging facilities related to the first information determined by the control unit 13 is not limited to three.

The control unit 13 acquires, for example, information on meandering driving in association with the driving of the vehicle 40 traveling to the lodging facility A1, as the traveling information. In addition, the control unit 13 acquires information indicating that an adult male is wearing a business suit as the appearance information of the occupants of the vehicle 40. At this time, the control unit 13 compares the traveling information and the appearance information with the big data stored in the storage unit 12. Consequently, the control unit 13 estimates that a fatigue level is 90 as the biological information of the occupants of the vehicle 40. The control unit 13 determines details of a bathing service provided at the lodging facility A1 as the first information that matches the estimated biological information indicating that the fatigue level is 90.

The control unit 13 acquires, for example, information indicating that the occupants have been present in the vehicle for a long time in association with driving of the vehicle 40 traveling to the lodging facility A2, as the traveling information. In addition, the control unit 13 acquires information indicating that an elementary school student boards the vehicle as the appearance information of the occupants of the vehicle 40. At this time, the control unit 13 compares the traveling information and the appearance information with the big data stored in the storage unit 12. Consequently, the control unit 13 estimates that a hunger level is 90 as the biological information of the occupants of the vehicle 40. The control unit 13 determines details of a meal service provided at the lodging facility A2 as the first information that matches the estimated biological information indicating that the hunger level is 90.

The control unit 13 acquires, for example, a high average vehicle speed in association with the driving of the vehicle 40 traveling to the lodging facility A3, as the traveling information. In addition, the control unit 13 acquires information indicating that an adult female is wearing plain clothes as the appearance information of the occupants of the vehicle 40. At this time, the control unit 13 compares the traveling information and the appearance information with the big data stored in the storage unit 12. Consequently, the control unit 13 estimates that an excitement level is 90 as the biological information of the occupants of the vehicle 40. The control unit 13 determines details of a tour guide service provided at the lodging facility A3 as the first information that matches the estimated biological information indicating that the excitement level is 90.

The control unit 13 may select, for example, the lodging facility that matches the appearance information and the number of the occupants of the vehicle 40, from among the candidate lodging facilities. At this time, the first information includes details of the services provided at the lodging facility selected by the control unit 13. The control unit 13 receives, for example, the facility information of the lodging facility stored in the storage unit 22 of the first terminal device 20 from each of the first terminal devices 20 provided in the lodging facilities, via the network 50 and the communication unit 11. The control unit 13 compares, for example, the received facility information of the lodging facilities with the appearance information and the number of the occupants of the vehicle 40. The control unit 13 may select, for example, a lodging facility that matches the appearance information and the number of the occupants of the vehicle 40, from among the candidate lodging facilities, based on the comparison stated above.

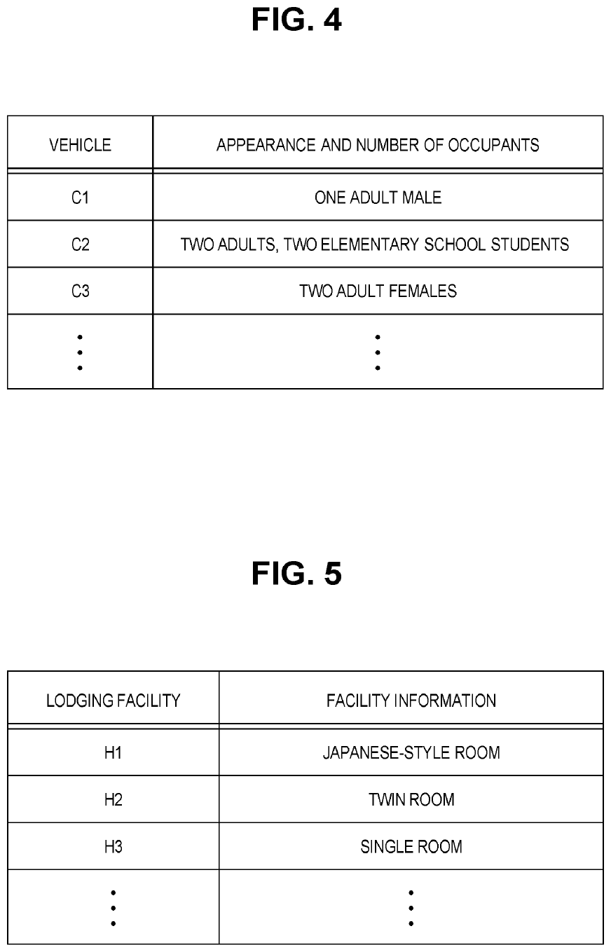

FIG. 4 is a first diagram illustrating a second example of the processing executed by the control unit 13 of the information processing apparatus 10 shown in FIG. 2. FIG. 5 is a second diagram illustrating the second example of the processing executed by the control unit 13 of the information processing apparatus 10 shown in FIG. 2. Referring to FIGS. 4 and 5, the second example of the processing executed by the control unit 13 will be described more specifically. In the second example of the processing executed by the control unit 13, a lodging facility is selected based on the appearance information and the number of the occupants, as well as the facility information of the lodging facility, acquired by the control unit 13.

As shown in FIG. 5, the control unit 13 acquires, for example, the facility information of the lodging facility from each of the first terminal devices 20 provided in candidate lodging facilities H1, H2 and H3. In FIG. 5, three lodging facilities H1, H2 and H3 are shown as the candidate lodging facilities, but the number of the candidate lodging facilities does not have to be three.

The control unit 13 acquires, for example, vacancy information indicating that a Japanese-style room is vacant in the lodging facility H1, as the facility information of the lodging facility. The control unit 13 acquires, for example, vacancy information indicating that a twin room is vacant in the lodging facility H2, as the facility information of the lodging facility. The control unit 13 acquires, for example, vacancy information indicating that a single room is vacant in the lodging facility H3, as the facility information of the lodging facility.

On the other hand, as shown in FIG. 4, the control unit 13 acquires the appearance information and the number of the occupants of the vehicles 40 from, for example, each of vehicles C1, C2 and C3. In FIG. 4, three vehicles C1, C2, and C3 are shown as the vehicles 40, but the number of the vehicles 40 is not limited to three.

The control unit 13 acquires, for example, information indicating that an adult male is wearing a business suit in the vehicle C1, as the appearance information and information indicating the number of the occupants of the vehicle 40. The control unit 13 acquires, for example, information indicating that two adults and two elementary school students board the vehicle C2, as the appearance information and information indicating the number of the occupants of the vehicle 40. The control unit 13 acquires, for example, information indicating that two adult females board the vehicle C3, as the appearance information and information indicating the number of the occupants of the vehicle 40.

At this time, the control unit 13 compares the facility information of the lodging facilities with the appearance information and the number of the occupants of the vehicle 40, and determines that the vacancy information indicating that a single room is vacant in the lodging facility H3 matches the appearance information and the number of the occupants of the vehicle C1. Therefore, the control unit 13 selects the lodging facility H3 as a lodging facility where the occupants of the vehicle C1 will stay, from among the candidate lodging facilities. The control unit 13 transmits the facility information of the selected lodging facility H3 to the vehicle C1 via the communication unit 11 and the network 50.

The control unit 13 compares the facility information of the lodging facilities with the appearance information and the number of the occupants of the vehicle 40, and determines that the vacancy information indicating that a Japanese-style room is vacant in the lodging facility H1 matches the appearance information and the number of the occupants of the vehicle C2. Therefore, the control unit 13 selects the lodging facility H1 as the lodging facility where the occupants of the vehicle C2 will stay, from among the candidate lodging facilities. The control unit 13 transmits the facility information of the selected lodging facility H1 to the vehicle C2 via the communication unit 11 and the network 50.

The control unit 13 compares the facility information of the lodging facilities with the appearance information and the number of the occupants of the vehicle 40, and determines that the vacancy information indicating that a twin room is vacant in the lodging facility H2 matches the appearance information and the number of the occupants of the vehicle C3. Therefore, the control unit 13 selects the lodging facility H2 as the lodging facility where the occupants of the vehicle C3 will stay, from among the candidate lodging facilities. The control unit 13 transmits the facility information of the selected lodging facility H2 to the vehicle C3 via the communication unit 11 and the network 50.

When it is determined that the biological information reaches a threshold, the control unit 13 determines the second information which matches the biological information. The occupants of the vehicle 40 which is traveling are informed of the second information, and the second information is associated with details of the services provided in the service facility existing on the travel route to the lodging facility. The control unit 13 transmits, for example, the determined second information to the second terminal device 30 and the vehicle 40 via the communication unit 11 and the network 50. In the detailed description, when the biological information may be, for example, represented by a value within an optional numerical range, the “threshold” includes a value of the biological information which falls within the numerical range.

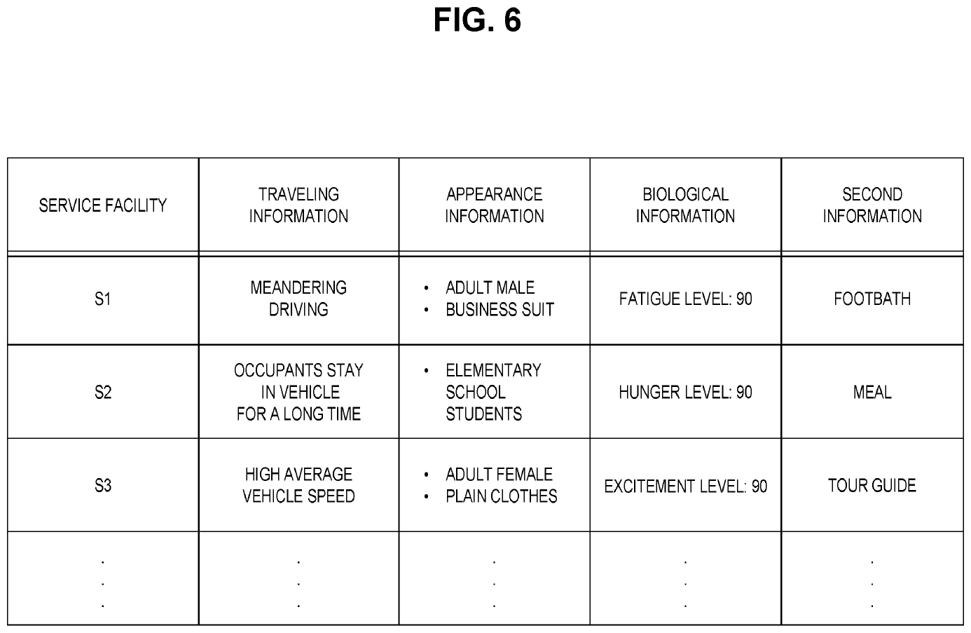

FIG. 6 is a diagram illustrating a third example of the processing executed by the control unit 13 of the information processing apparatus 10 shown in FIG. 2. Referring to FIG. 6, the third example of the processing executed by the control unit 13 will be described more specifically. In the third example of the processing executed by the control unit 13, the second information is determined so as to match the biological information estimated by the control unit 13. Three service facilities S1, S2 and S3 are shown in FIG. 6, but the number of the service facilities related to the second information determined by the control unit 13 is not limited to three.

The control unit 13 estimates, for example, that the fatigue level is 90 in terms of the driving of the vehicle 40 to the lodging facility A1, as the biological information of the occupants of the vehicle 40, as in the description of FIG. 3. The control unit 13 determines, for example, that the threshold is set to 80 and the fatigue level reaches the threshold. At this time, the control unit 13 determines the second information related to the service provided at the service facility S1 existing on the travel route to the lodging facility A1, which matches the biological information indicating that the fatigue level is 90. More specifically, the control unit 13 determines details of a footbath service provided at the service facility S1 as the second information that matches the estimated biological information indicating that the fatigue level is 90.

The control unit 13 estimates, for example, that the hunger level is in terms of the driving of the vehicle 40 to the lodging facility A2, as the biological information of the occupants of the vehicle 40, as in the description of FIG. 3. The control unit 13 determines, for example, that the threshold is set to 80 and the hunger level reaches the threshold. At this time, the control unit 13 determines the second information associated with the service provided at the service facility S2 existing on the travel route to the lodging facility A2, which matches the biological information indicating that the hunger level is 90. More specifically, the control unit 13 determines details of a meal service provided at the service facility S2 as the second information that matches the estimated biological information indicating that the hunger level is 90.

The control unit 13 estimates, for example, that the excitement level is 90 in terms of driving of the vehicle 40 to the lodging facility A3, as the biological information of the occupants of the vehicle 40, as in the description of FIG. 3. The control unit 13 determines, for example, that the threshold is set to 80 and the excitement level reaches the threshold. At this time, the control unit 13 determines the second information associated with the service provided at the service facility S3 existing on the travel route to the lodging facility A3, which matches the biological information indicating that the excitement level is 90. More specifically, the control unit 13 determines details of a tour service provided at the service facility S3 as the second information that matches the estimated biological information indicating that the excitement level is 90.

The control unit 13 may select, for example, one service facility that matches the driving history of the occupants of the vehicle 40, from among the candidate service facilities. At this time, the second information includes details of the services provided at the service facility selected by the control unit 13. The control unit 13 receives, for example, the facility information of the service facility stored in the storage unit 32 of the second terminal device 30 from each of the second terminal devices 30 provided in the service facilities, via the network 50 and the communication unit 11. The control unit 13 receives, for example, the driving history stored in the storage unit 42 of the vehicle 40 from the vehicle 40 via the network 50 and the communication unit 11. The control unit 13 compares, for example, the received facility information of the service facilities with the driving history of the occupants of the vehicle 40. The control unit 13 may select, for example, a service facility that matches the driving history of the occupants of the vehicle 40, from among the candidate service facilities, based on the comparison stated above.

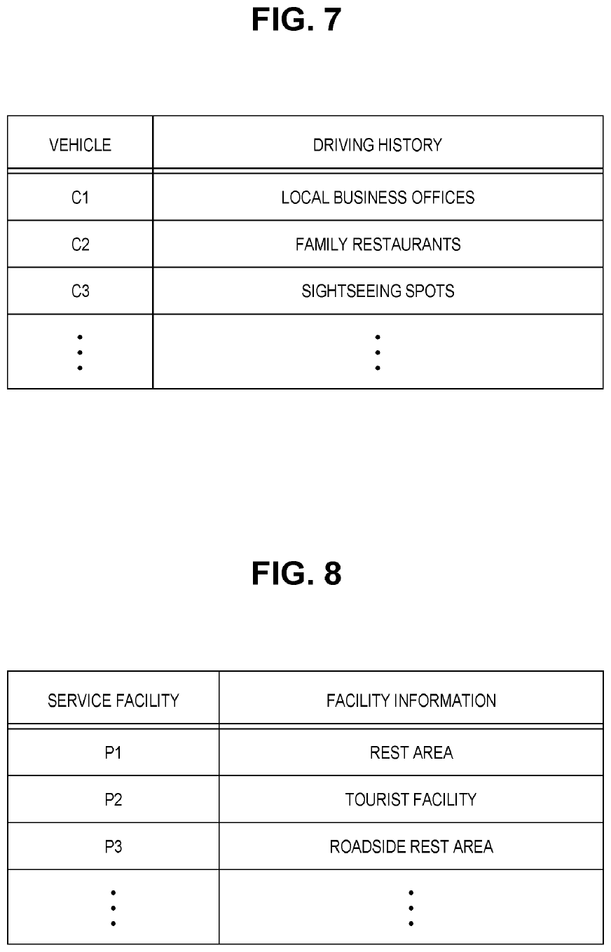

FIG. 7 is a first diagram illustrating a fourth example of the processing executed by the control unit 13 of the information processing apparatus 10 shown in FIG. 2. FIG. 8 is a second diagram illustrating the fourth example of the processing executed by the control unit 13 of the information processing apparatus 10 shown in FIG. 2. Referring to FIGS. 7 and 8, the fourth example of the processing executed by the control unit 13 will be described more specifically. In the fourth example of the processing executed by the control unit 13, one service facility is selected based on the driving history of the occupants, as well as the facility information of the service facility, acquired by the control unit 13.

As shown in FIG. 8, the control unit 13 acquires, for example, the facility information of the service facility from each of the second terminal devices 30 provided in candidate service facilities P1, P2 and P3. In FIG. 8, three service facilities P1, P2 and P3 are shown as the candidates, but the number of the candidate service facilities is not limited to three.

The control unit 13 acquires, for example, information on a type of the service facility indicating that the service facility P1 is a rest area, as the facility information of the service facility. The control unit 13 acquires, for example, information on a type of the service facility indicating that the service facility P2 is a tourist facility, as the facility information of the service facility. The control unit 13 acquires, for example, information on a type of the service facility indicating that the service facility P3 is a roadside rest area (government-designated rest stops found along roads and highways in Japan), as the facility information of the service facility.

On the other hand, as shown in FIG. 7, the control unit 13 acquires the driving history of the occupants of the vehicles 40 from, for example, each of vehicles C1, C2 and C3. In FIG. 7, three vehicles C1, C2, and C3 are shown as the vehicles 40, but the number of the vehicles 40 is not limited to three.

The control unit 13 acquires, for example, information indicating that the occupant of the vehicle C1 frequently stops by local business offices, as the driving history of the occupant of the vehicle 40. The control unit 13 acquires, for example, information indicating that the occupant of the vehicle C2 frequently stops by family restaurants, as the driving history of the occupant of the vehicle 40. The control unit 13 acquires, for example, information indicating that the occupant of the vehicle C3 frequently stops by sightseeing spots, as the driving history of the occupant of the vehicle 40.

At this time, the control unit 13 compares the facility information of the service facilities with the driving history of the occupant of the vehicle 40, and determines that the facility information indicating that the service facility P3 is a roadside rest area matches the driving history of the occupant of the vehicle C1 Therefore, the control unit 13 selects the service facility P3 as a service facility where the occupant of the vehicle C1 can stop on the travel route to the lodging facility, from among the candidate service facilities. The control unit 13 transmits the facility information of the selected service facility P3 to the vehicle C1 via the communication unit 11 and the network 50.

The control unit 13 compares the facility information of the service facilities with the driving history of the occupant of the vehicle 40, and determines that the facility information indicating that the service facility P1 is a rest area matches the driving history of the occupant of the vehicle C2. Therefore, the control unit 13 selects the service facility P1 as a service facility where the occupant of the vehicle C2 can stop on the travel route to the lodging facility, from among the candidate service facilities. The control unit 13 transmits the facility information of the selected service facility P1 to the vehicle C2 via the communication unit 11 and the network 50.

The control unit 13 compares the facility information of the service facilities with the driving history of the occupants of the vehicle 40, and determines that the facility information indicating that the service facility P2 is a tourist facility matches the driving history of the occupants of the vehicle C3. Therefore, the control unit 13 selects the service facility P2 as a service facility where the occupants of the vehicle C3 can stop on the travel route to the lodging facility, from among the candidate service facilities. The control unit 13 transmits the facility information of the selected service facility P2 to the vehicle C3 via the communication unit 11 and the network 50.

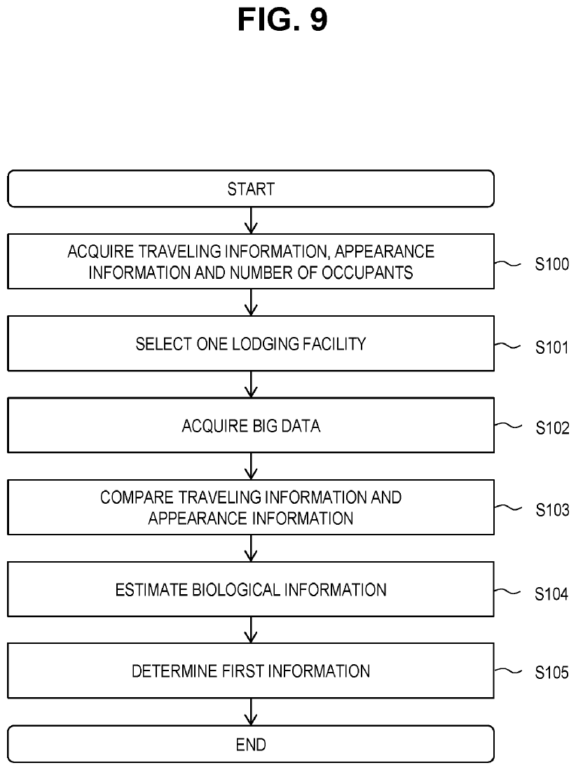

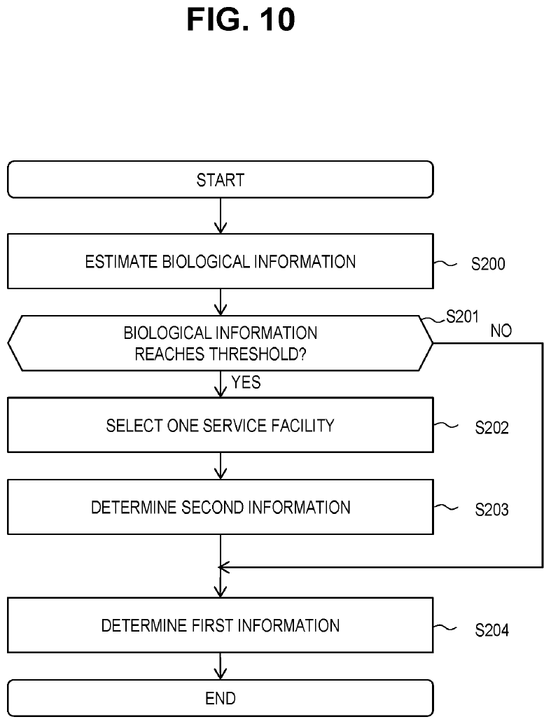

Hereinbelow, an information processing method executed by the control unit 13 of the information processing apparatus 10 according to the embodiment will be described referring to FIGS. 9 and 10. FIG. 9 is a flowchart illustrating a first example of the information processing method executed by the information processing apparatus 10 shown in FIG. 1. The flowchart of FIG. 9 shows a case where the lodging facility has not been reserved by the occupants of the vehicle 40 in advance, and one lodging facility is selected by the control unit 13.

In step S100, the control unit 13 acquires the traveling information of the vehicle 40, as well as the appearance information and the number of the occupants of the vehicle 40, which are obtained in association with the driving of the vehicle 40 traveling to the lodging facility.

In step S101, the control unit 13 selects the lodging facility that matches the appearance information and the number of the occupants of the vehicle 40, acquired in step S100, from among the candidate lodging facilities.

In step S102, the control unit 13 acquires the big data in which the traveling information and the appearance information previously obtained in association with the driving of the other vehicle are associated with the biological information of the occupants of the other vehicle.

In step S103, the control unit 13 compares the traveling information and the appearance information, acquired in step S100, with the traveling information and the appearance information previously obtained in association with the driving of the other vehicle. At this time, the control unit 13 uses the big data acquired in step S102.

In step S104, the control unit 13 estimates the biological information of the occupants of the vehicle 40 based on the comparison in step S103.

In step S105, the control unit 13 determines the first information associated with the service provided at the lodging facility, which matches the biological information estimated in step S104. The control unit 13 notifies the occupants of the traveling vehicle 40 and the manager of the lodging facility related to the first information of the determined first information. At this time, the control unit 13 also notifies the manager of the lodging facility related to the first information of personal information such as names of the occupants of the vehicle 40, if necessary.

Notwithstanding the above, step S101 may be omitted when the lodging facility is reserved by the occupants of the vehicle 40 in advance. At this time, the control unit 13 also notifies the manager of the lodging facility related to the first information of reservation information such as names of the occupants of the vehicle 40, if necessary, in step S105. In step S102, the control unit 13 may acquire any data in which the traveling information and the appearance information previously obtained in association with the driving of the other vehicle are associated with the biological information of the occupants of the other vehicle, instead of the big data.

FIG. 10 is a flowchart illustrating a second example of the information processing method executed by the information processing apparatus 10 shown in FIG. 1. The flowchart of FIG. 10 includes a case where one service facility existing on the travel route of the vehicle 40 to the lodging facility is selected by the control unit 13.

In step S200, the control unit 13 estimates the biological information of the occupants of the vehicle 40 based on the same flow as the flow from step S100 to step S104 of FIG. 9.

In step S201, the control unit 13 determines whether or not the biological information estimated in step S200 reaches the threshold. When it is determined that the biological information reaches the threshold, the control unit 13 executes the processing of step S202. When it is determined that the biological information does not reach the threshold, the control unit 13 executes the processing of step S204.

In step S202, the control unit 13 selects, when it is determined that the biological information reaches the threshold in step S201, a service facility that matches the driving history of the occupants of the vehicle 40, from among the candidate service facilities.

In step S203, the control unit 13 determines the second information associated with the service provided at the service facility existing on the travel route to the lodging facility selected in S202, which matches the biological information estimated in step S200. The control unit 13 notifies the occupants of the traveling vehicle 40 and the manager of the service facility related to the second information of the determined second information. At this time, the control unit 13 also notifies the manager of the service facility related to the second information of personal information such as names of the occupants of the vehicle 40, if necessary.

In step S204, the control unit 13 determines the first information associated with the service provided at the lodging facility, which matches the biological information estimated in step S200. The control unit 13 notifies the occupants of the traveling vehicle 40 and the manager of the lodging facility related to the first information of the determined first information. At this time, the control unit 13 also notifies the manager of the lodging facility related to the first information of personal information such as names of the occupants of the vehicle 40, if necessary.

With the embodiment stated above, it is possible to optimize the services provided at the lodging facility to meet the needs of the occupants of the vehicle 40, based on the biological information of the occupants. The information processing apparatus 10 estimates, for example, the biological information of the occupants of the vehicle 40 and determines the first information that matches the estimated biological information, and thus the manager of the lodging facility, who receives the first information, can provide optimally customized services required by the occupants of the vehicle 40 based on the biological information. That is, in the past, the lodging facility could only offer the same services to all guests. However, presently, optimally customized services can be offered at the lodging facility for each of the occupants of the vehicle 40. Consequently, the quality of the services provided to the occupants at the lodging facility is improved, thereby increasing the satisfaction of the occupants in terms of the services offered at the lodging facility. Accordingly, the lodging facility can attract more customers.

The first information includes, for example, details of services provided at the lodging facility reserved by the occupants of the vehicle 40 in advance. Consequently, it is possible to provide optimally customized services for each occupant at the lodging facility at which the occupants desire to stay and have booked in advance. Therefore, the manager of the lodging facility can satisfy the occupants who have booked the lodging facility in advance while expecting high-quality services. Accordingly, the occupants can feel satisfied as guests, and the lodging facility can receive a better evaluation from the occupants.

The information processing apparatus 10 selects the lodging facility that matches the appearance information and the number of the occupants of the vehicle 40, and thus, for example, the occupants can stay at the lodging facility with a vacancy optimally matching their appearance information and the number of occupants. At this time, the first information includes details of the services provided at the selected lodging facility, and thus it is possible to provide optimally customized services for each occupant even in the case where the lodging facility is selected by the information processing apparatus 10 regardless of the occupants' desire for the type of lodging facility. Therefore, the manager of the lodging facility can make a good impression on the occupants even though the occupants do not know anything about the lodging facility. Accordingly, the satisfaction of the occupants can be enhanced, and the lodging facility can receive a better evaluation from the occupants.

The information processing apparatus 10 determines, when it is determined that the biological information reaches the threshold, the second information that matches the biological information. Consequently, for example, even when the occupants of the vehicle 40 stop by the service facility as notified by the output unit 44 on the way to the lodging facility, it is possible to optimize the services provided at the service facility so as to match the needs of the occupants, the service facility being determined based on the biological information of the occupants of the vehicle 40. The information processing apparatus 10 estimates, for example, the biological information of the occupants of the vehicle 40 and determines the second information that matches the estimated biological information, and thus the manager of the service facility, who receives the second information, can provide optimally customized services required by the occupants of the vehicle 40 based on the biological information. That is, in the past, the service facility could only offer the same services to each guest. However, presently, the service facility can offer optimally customized services at the service facility for each of the occupants of the vehicle 40. Consequently, the quality of the services provided to the occupants at the service facility is improved, thereby increasing the satisfaction of the occupants in terms of the services offered at the service facility. Accordingly, the service facility can attract more customers.

The information processing apparatus 10 selects one service facility that matches the driving history of the occupant of the vehicle 40, and thus, for example, the occupant can stop by the service facility that provides optimally customized services that match the driving history. At this time, the second information includes details of the services provided at the selected service facility, and thus it is possible to provide optimally customized services for each occupant even in the case where the service facility is selected by the information processing apparatus 10 regardless of the occupants' desire for the type of service facility. Therefore, the manager of the service facility can make a good impression on the occupants even when the occupants do not know anything about the service facility. Accordingly, the satisfaction of the occupants can be enhanced, and the service facility can receive a better evaluation from the occupants.

The information processing apparatus 10 acquires the big data in which the traveling information and the appearance information previously obtained in association with the driving of the other vehicle are associated with the biological information of the occupants of the other vehicle, and compares the big data with the traveling information of the vehicle 40 and the appearance information of the occupants, thereby accurately estimating the biological information. Consequently, the information processing apparatus 10 can more accurately optimize the services provided at the lodging facility based on the biological information of the occupants of the vehicle 40. Accordingly, the manager of the lodging facility, who receives the first information, can accurately provide optimally customized services required by the occupants of the vehicle 40 based on the biological information.

The biological information includes the fatigue level of the occupants of the vehicle 40, and thus the information processing apparatus 10 can optimize the services provided at the lodging facility for the needs of the occupants based on the fatigue level of the occupants of the vehicle 40. The information processing apparatus 10 estimates, for example, the fatigue level of the occupants of the vehicle 40 and determines the first information that matches the estimated fatigue level, and thus the manager of the lodging facility, who receives the first information, can provide optimally customized services required by the occupants of the vehicle 40 based on the fatigue level.

Although the present disclosure has been described based on the drawings and examples, it should be noted that those skilled in the art could easily make various changes and modifications based on the present disclosure. Therefore, those variations and modifications are encompassed in the scope of the claims of the present disclosure. For example, functions included in each configuration or each step can be rearranged without logical contradiction, and it is possible to combine into a single component or divide a plurality of configurations or steps.

For example, at least any part of processing operations executed in the information processing apparatus 10 in the embodiment stated above may be executed in at least one of the first terminal device 20, the second terminal device 30, and the vehicle 40. For example, instead of the information processing apparatus 10, the vehicle 40 may execute the processing operations related to the information processing apparatus 10 stated above. At least any part of the processing operations executed in at least one of the first terminal device 20, the second terminal device 30, and the vehicle 40 may be executed in the information processing apparatus 10.

For example, the information processing system 1 may have only the information processing apparatus 10 and one vehicle 40, without including the first terminal device 20 and the second terminal device 30.

For example, it is also possible to employ a configuration in which a general-purpose electronic device such as a smartphone or a computer functions as the information processing apparatus 10 according to the embodiment stated above. In particular, a program describing processing contents for implementing each function of the information processing apparatus 10 and the like according to the embodiment is stored in the memory of the electronic device, and the program is read and executed by a processor of the electronic device. Therefore, the disclosure according to one embodiment can also be implemented as a program that can be executed by a processor. Alternatively, the present disclosure according to the embodiment can be implemented by a transitory computer-readable medium that stores a program executable by one or more processors to cause, for example, the information processing apparatus 10 according to the embodiment to execute each function. It should be noted that these embodiments are also encompassed in the scope of the present disclosure.

For example, the information processing apparatus 10 has been described as being mounted on the vehicle 40 in the embodiment stated above. At this time, the information processing apparatus 10 may establish information communication directly with the vehicle 40, not via the network 50.

In the embodiment stated above, it has been described that the service facility existing on the travel route to the lodging facility is selected by the information processing apparatus 10, but the present disclosure is not limited thereto. The service facility may be selected and booked in advance by the occupants of the vehicle 40.

In the embodiment stated above, it has been described that the information processing apparatus 10 acquires the big data from any other external device via the network 50 and the communication unit 11, but the present disclosure is not limited thereto. The information processing apparatus 10 may generate the big data in which the traveling information and the appearance information, previously obtained in association with driving of the other vehicle, are associated with the biological information of the occupants of the other vehicle, and store the big data in the storage unit 12.

What is claimed is:

1. An information processing apparatus comprising:
a control unit configured to:
acquire traveling information of one vehicle and appearance information of an occupant of the one vehicle, which are obtained in association with driving of the one vehicle to a lodging facility;
estimate biological information of the occupant of the one vehicle by comparing the acquired traveling information and the acquired appearance information with traveling information and appearance information previously obtained in association with driving of other vehicles; and
determine first information associated with a service provided at the lodging facility, the service being matched with the estimated biological information.

2. The information processing apparatus according to claim 1, wherein the first information includes details of a service provided at the lodging facility reserved by the occupants of the one vehicle in advance.

3. The information processing apparatus according to claim 1, wherein:
the control unit is configured to select one lodging facility matching the appearance information and the number of occupants of the one vehicle, from among a plurality of candidate lodging facilities; and
the first information includes details of a service provided at the selected lodging facility.

4. The information processing apparatus according to claim 1, wherein the control unit is configured to, upon determining that the biological information reaches a threshold, determine second information matching the biological information, the occupant of the one vehicle which is traveling being informed of the second information, and the second information being associated with details of a service provided in a service facility existing on a travel route to the lodging facility.

5. The information processing apparatus according to claim 4, wherein:
the control unit is configured to select one service facility matching a driving history of the occupant of the one vehicle, from among a plurality of candidate service facilities; and
the second information includes details of a service provided at the selected service facility.

6. The information processing apparatus according to claim 1, wherein the control unit is configured to acquire big data in which the traveling information and the appearance information previously obtained in association with driving of the other vehicles are associated with biological information of occupants of the other vehicles.

7. The information processing apparatus according to claim 1, wherein the biological information includes a fatigue level of the occupant of the one vehicle.

8. An information processing system comprising:
the information processing apparatus according to claim 1; and
the one vehicle configured to provide the traveling information and the appearance information to the information processing apparatus.

9. A program causing an information processing apparatus to execute an operation, the operation comprising:
acquiring traveling information of one vehicle and appearance information of an occupant of the one vehicle, which are obtained in association with driving of the one vehicle to a lodging facility;
estimating biological information of the occupant of the one vehicle by comparing the acquired traveling information and the acquired appearance information with traveling information and appearance information previously obtained in association with driving of other vehicles; and
determining first information associated with a service provided at the lodging facility, the service being matched with the estimated biological information.

10. The program according to claim 9, wherein the first information includes details of a service provided at the lodging facility reserved by the occupant of the one vehicle in advance.

11. The program according to claim 10, wherein:
the operation includes selecting one lodging facility matching the appearance information and the number of the occupants of the one vehicle, from among a plurality of candidate lodging facilities; and
the first information includes details of a service provided at the selected lodging facility.

12. The program according to claim 9, wherein the operation includes determining, upon determining that the biological information reaches a threshold, second information matching the biological information, the occupant of the one vehicle which is traveling being informed of the second information, and the second information being associated with details of a service provided in a service facility existing on a travel route to the lodging facility.

13. The program according to claim 12, wherein:
the operation includes selecting one service facility matching a driving history of the occupant of the one vehicle, from among a plurality of candidate service facilities; and
the second information includes details of a service provided at the selected service facility.

14. The program according to claim 9, wherein the operation includes acquiring big data in which the traveling information and the appearance information previously obtained in association with the driving of the other vehicles are associated with biological information of occupants of the other vehicles.

15. A vehicle comprising:
a control unit configured to:
acquire traveling information of the vehicle and appearance information of an occupant of the vehicle, which are obtained in association with driving of the vehicle to a lodging facility;
estimate biological information of the occupant of the vehicle by comparing the acquired traveling information and the acquired appearance information with traveling information and appearance information previously obtained in association with driving of other vehicles; and
determine first information associated with a service provided at the lodging facility, the service being matched with the estimated biological information.

16. The vehicle according to claim 15, wherein the first information includes details of a service provided at the lodging facility reserved by the occupant of the vehicle in advance.

17. The vehicle according to claim 15, wherein:
the control unit is configured to select one lodging facility matching the appearance information and the number of the occupants of the vehicle, from among a plurality of candidate lodging facilities; and
the first information includes details of a service provided at the selected lodging facility.

18. The vehicle according to claim 15, wherein the control unit is configured to, upon determining that the biological information reaches a threshold, determine second information matching the biological information, the occupant of the vehicle which is traveling being informed of the second information, and the second information being associated with details of a service provided in a service facility existing on a travel route to the lodging facility.

19. The vehicle according to claim 18, wherein:
the control unit is configured to select one service facility matching a driving history of the occupant of the vehicle, from among a plurality of candidate service facilities; and
the second information includes details of a service provided in the selected service facility.

20. The vehicle according to claim 15, wherein the control unit is configured to acquire big data in which the traveling information and the appearance information previously obtained in association with the driving of the other vehicles are associated with biological information of occupants of the other vehicles.
